(19) United States
(12) Patent Application Publication
(10) Pub. No.: US 2006/0170756 A1
(43) Pub. Date: Aug. 3, 2006

(54) Heat-development recording apparatus and heat-development recording method

(75) Inventor: Hajime Ishimoto, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/335,424

(22) Filed: Jan. 18, 2006

(30) Foreign Application Priority Data
Jan. 28, 2005 (JP) JP2005-021450

(51) Int. Cl. G01D 15/14

(52) U.S. Cl. 347/228

(57) ABSTRACT

This heat-development recording apparatus 1 provides with an exposure section 15 that forms the latent image by exposing the film F, heating sections 10 and 13 that develop the film by heating, a rapid cooling section 14 that cools the heated film, a density correction section 18 that mates with the heated film transported to the cooling section and that controls the final density of the film by varying the quantity of heat absorbed from the film, and a control section that controls the density correction section.

This application is based on Japanese Patent Application No. 2005-021450 filed on Jan. 28, 2005 in Japanese Patent Office, the entire content of which is hereby incorporated by reference.

### BACKGROUND OF THE INVENTION

The present invention relates to heat-development recording apparatus and heat-development recording method of heating, developing, and cooling sheet-shaped heat-development photosensitive material on which a latent image has been formed.

Heat-development recording apparatuses and methods have been known by which a latent image formed by laser light beam on a film made of a heat-development photosensitive material is made visible by developing the latent image by heating. A density correction method by measuring the density of a patch formed on a film by a heat-development recording apparatus so that the next print has appropriate density by feeding back the result of that measurement has been known in Patent Document 1 and the like shown below. In this method, the feedback correction becomes effective during continuous processing only after a few sheets have been finished.

In contrast with this, Patent Document 2 below discloses a method in which the correction is carried out by detecting the heating temperature of the film, and changing the development time by controlling the film conveying speed (the drum rotational speed) according to the detected temperature, thereby aiming to stabilize the density. This method is a system with which it is possible to obtain appropriate density even during continuous processing. In this system, the heating time is varied in real time according to temporary cooling capacity.

Further, in the method of carrying out heat development while exposing, as in the disclosure in Patent Document 3 below, since the film conveying speed cannot be variable, the variable speed method cannot be used. This is because changing the conveying speed during exposure (the sub-canning speed) implies changing the magnification ratio of the image in the conveying direction.

Further, as disclosed in Patent Document 4 below, there is also the method of detecting the air temperature or member temperature in the neighborhood of the development section such as in the heating section, the cooling section, feeding it back to the exposure system or carrying out control as in Patent Document 2, and adjusting (correcting) the intensity of light to which the film is exposed. In this method, it is necessary to carry out exposure correction operation for the stabilization of density, in addition to carrying out the image processing operation (exposure determination) for outputting the image data that has been inputted, with the appropriate gradation characteristics, and hence time is taken to generate the print data thereby lowering the print productivity of the apparatus.

Patent Document 1: Japanese Unexamined Patent Application Open to Public Inspection No. 2003-140271

Patent Document 2: Japanese Unexamined Patent Application Open to Public Inspection No. 2003-195467

Patent Document 3: Japanese Unexamined Patent Application Open to Public Inspection No. 2003-287862

Patent Document 4: Japanese Unexamined Patent Application Open to Public Inspection No. 2000-284382

### SUMMARY OF THE INVENTION

In view of the above problems in the conventional technology, a purpose of the present invention is to provide a heat-development recording apparatus and a heat-development recording method of a new density correction system and method that are ideally suitable for stabilizing the density of developed film in carrying out heat development while carrying out exposure.

In order to achieve the above purpose, the heat-development recording apparatus according to the present invention is provided with an exposure section that exposes a heat-development photosensitive sheet material to light thereby forming a latent image on it, a heating section that develops by heating the heat-development photosensitive sheet material, and a cooling section that cools the heated heat-development photosensitive sheet material, with the apparatus having the feature that it is further provided with a density correction section that controls the density of the heat-development photosensitive material by engaging with the heated heat-development photosensitive sheet material conveyed to the cooling section and varies the quantity of heat absorbed from the heat-development photosensitive material, and a control section that controls the density correction section.

Further, the heat-development recording method according to the present invention is a method of exposing a heat-development photosensitive sheet material to light thereby forming a latent image on it, developing by heating the heat-development photosensitive sheet material, and cooling the heated heat-development photosensitive sheet material, with the method having the feature that density correction is carried out by controlling the density of the heat-development photosensitive material by varying the quantity of heat absorbed from the heated heat-development photosensitive sheet material conveyed for the cooling.

### BRIEF DESCRIPTION OF THE DRAWINGS

FIG. 1 is a side view diagram showing the outlines of the major parts of a heat-development recording apparatus according to the present preferred embodiment.

FIG. 2 is a block diagram showing the major parts of the control system of the heat-development recording apparatus of FIG. 1.

FIG. 3 is a graph showing the temperature profile in the rapid processing method of the heat development process in the heat-development recording apparatus of FIG. 1.

FIG. 4 is a side view diagram showing the configuration of major parts of the heat-development recording apparatus used in the preferred embodiment.

### DETAILED DESCRIPTION OF THE PREFERRED EMBODIMENT

According to the present heat-development recording apparatus, when the heated heat-development photosensitive sheet material is separated from the heating section and is conveyed in the downstream direction (towards ejection), the progressing time of development of the heat-development photosensitive material can be varied even when the speed of the conveyance of the material is constant, by controlling the quantity of heat absorbed (quantity of transferred heat) from the heated heat-development photosensitive material which is engaged with the density correction section provided on the downstream side of the heating section, in other words, by controlling the extent to which the heated heat-development photosensitive material is cooled. Thereby, the final density of the heat-development photosensitive material can be controlled, and an ideal and new density correction system can be realized when the heat development and the exposure are being carried out at the same time. Because of this, smaller sizes of heat-development recording apparatuses are realized and the final density of the photosensitive material is stabilized.

In the above heat-development recording apparatus, because the exposure section and the heating section act simultaneously on the heat-development photosensitive sheet material, heat development at the front edge of the heat-development photosensitive sheet material in the conveying direction can be carried out while exposure on the rear edge side in the conveying direction is being carried out, and hence smaller sizes of the apparatuses can be realized.

Further, it is desirable that the density correction section has a guide that comes into contact with the heated heat-development photosensitive sheet material, and a heating section provided on the surface of the guide opposite to the surface in contact with the heat-development photosensitive sheet material. The heated heat-development photosensitive sheet material is absorbed with its heat by being in contact with the guide whose surface temperature is controlled by the heating section (heat is transferred). By controlling the surface temperature of the guide by the heating section, the quantity of heat absorbed (quantity of transferred heat) from the heat-development photosensitive material can be controlled.

Further, it is desirable that the cooling section has a slow cooling section that cools the heated heat-development photosensitive sheet material up to the temperature at which the development stops, and a rapid cooling section that lowers the temperature of the heat-development photosensitive sheet material to a temperature at which the user can touch it (a temperature at which the user does not feel it hot when he touches it with a bare hand), and that the slow cooling section is placed on the upstream side of the rapid cooling section.

Further, the heating section is provided on the side at which the heat-development photosensitive sheet material enters the slow cooling section, and the slow cooling section can also be the density correction section. In this manner, the density correction section is configured to have a part of the slow cooling function of cooling the heated heat-development photosensitive sheet material up to the temperature at which the development stops.

Further, a temperature detection section is provided for detecting the temperature in the neighborhood of the slow cooling section and/or the exposure section. The control section can control the surface temperature of the guide and the quantity of heat absorbed (the quantity of transferred heat) from the heat-development photosensitive material by controlling the heating section of the density correction section based on the result of detection by the temperature detection section. Further, lowering of the density can be prevented because of the control of surface temperature of the guide, even when the wavelength of oscillation of the LD (laser diode) included in the exposure section changes due to the temperature rise and thus the amount of light in the photosensitive wavelength range of the heat-development photosensitive material becomes decreased.

In addition, size reduction of the apparatus and speedy heat development processing can be realized by conveying the heat-development photosensitive material so that the heating time of the heat-development photosensitive sheet material by the heating section is 10 seconds or less.

In a similar way, according to this heat-development recording method, when the heated heat-development photosensitive sheet material is conveyed in the downstream direction (towards ejection), the progressing time of development of the heat-development photosensitive material can be varied even when the speed of conveyance of the material is constant by controlling the quantity of heat absorbed (quantity of transferred heat) from the heated heat-development photosensitive material, in other words, by controlling the extent to which the heated heat-development photosensitive material is cooled. Thereby, the final density of the final heat-development photosensitive material can be controlled, and an ideal and new density correction method can be realized when the heat development and the exposure are being carried out at the same time. Because of this, smaller sizes of heat-development recording apparatuses are realized and the final density of the photosensitive material is stabilized.

In the above heat-development recording method, because the exposure and the heating are carried out simultaneously on the heat-development photosensitive sheet material, heat development at the front edge of the heat-development photosensitive sheet material in the conveying direction can be carried out while the exposure on the rear edge side in the conveying direction is being carried out, and hence smaller sizes of the apparatus can be realized.

Further, during the cooling, it is desirable that after cooling the heated heat-development photosensitive sheet material up to the temperature at which the development stops, the temperature of the heat-development photosensitive sheet material is lowered to a temperature at which the user can touch it (a temperature at which the user does not feel it hot when the user touches it with a bare hand). In this case, density correction of the heat-development photosensitive sheet material can be carried out during the slow cooling. In this manner, density correction can be carried out during slow cooling of cooling the heated heat-development photosensitive sheet material to a temperature below the temperature at which the development stops.

Further, during the density correction, it is desirable that the heated heat-development photosensitive sheet material comes into contact with a guide, and that the surface of the guide opposite to the surface in contact with the heat-development photosensitive sheet material is heated. The heated heat-development photosensitive sheet material is absorbed with its heat by being in contact with the guide whose surface temperature is controlled by the heating section (heat is transferred). By controlling the surface temperature of the guide by the heating section, the quantity of heat absorbed (quantity of transferred heat) from the heat-development photosensitive material can be controlled

Further, by detecting the temperature at the positions related to the slow cooling and/or the exposure and by controlling the heating of the guide based on the result of the temperature detection, the surface temperature of the guide and the quantity of heat absorbed (the quantity of transferred heat) from the heat-development photosensitive material can be controlled. Further, reductions in the density can be prevented because of the control of surface temperature of the guide, even when the wavelength of oscillation of the LD (laser diode) included in the exposure section changes due to the temperature rise and thus the amount of light in the photosensitive wavelength range of the heat-development photosensitive material becomes decreased.

In addition, size reduction of the apparatus and speedy heat development processing can be realized by conveying the heat-development photosensitive material so that the heating time of the heat-development photosensitive sheet material after forming the latent image is 10 seconds or less.

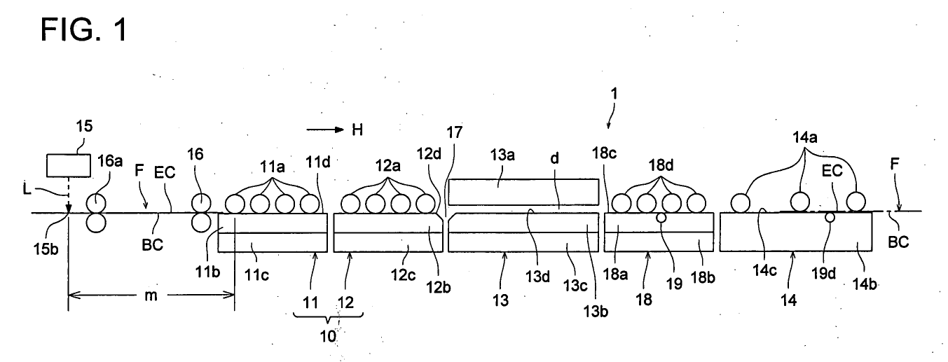

Hereinafter, the preferred embodiments for execution of the present invention will be explained with reference to the accompanying drawings. FIG. 1 is a front view schematically showing the main section of the heat-development recording apparatus of the embodiment.

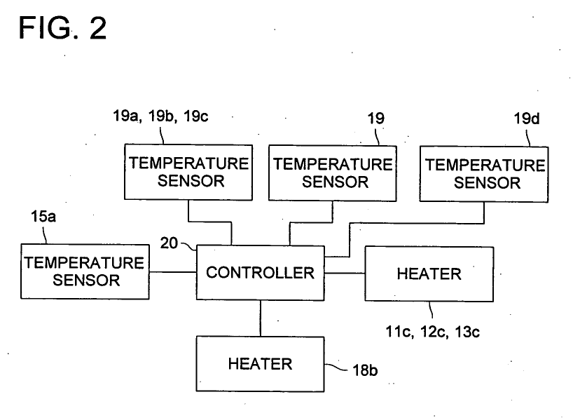

As shown in FIG. 1, a heat-development recording apparatus 1 of the embodiment, while carrying out sub-scanning conveyance with rollers 16a or the like, in the direction H, of a sheet film F (hereinafter, referred to as a film) having an EC surface where a heat-developing photosensitive material is coated on one side of a sheet-formed supporting substrate made of PET or the like and a BC surface on the opposite surface of the EC surface on the supporting substrate side, scans a laser beam L for exposure by an light scanning exposure section 15 on the basis of image data, thereby forms a latent image on the EC surface, then heats to develop the film F from the BC surface side, and makes the latent image visible. The light scanning exposure section 15 includes LD (Laser Diode) as a light source and a temperature sensor 15a (FIG. 2) measuring the temperature of the light source.

The heat-development recording apparatus 1 shown in FIG. 1 includes a temperature raising section 10 for heating the film F having the formed latent image, from the BC surface side and heating it up to a predetermined heat developing temperature, a temperature retaining section 13 for heating the temperature-raised film F and retaining it at the predetermined heat developing temperature, and a rapid cooling section 14 for cooling the heated film F from the BC surface side. The temperature raising section 10 and the temperature retaining section 13 compose a heating section, which heats the film F up to the heat developing temperature and retains it at the heat developing temperature.

The temperature raising section 10 has a first heating zone 11 for heating the film F on the upstream side and a second heating zone 12 for heating it on the downstream side. Further, at the rapid cooling section 14, a density correction section (slow cooling section) 18 that corrects the film density while cooling heated film F is disposed in the front part.

The first heating zone 11 includes a fixed flat heating guide 11b made of a metallic material such as aluminum, a flat heater 11c composed of a silicon rubber heater or the like adhered to the rear of the heating guide 11b, and a plurality of opposing rollers 11a having a surface composed of silicon rubber having heat insulation quality better than metal, which is arranged so as to keep a narrower gap than the film thickness in order to press the film against a stationary guide surface 11d of the heating guide 11b.

The second heating zone 12 includes a fixed flat heating guide 12b made of a metallic material such as aluminum, a flat heater 12c composed of a silicon rubber heater or the like adhered to the rear of the heating guide 12b, and a plurality of opposing rollers 12a having a surface composed of silicone rubber having heat insulation quality better than metal which is arranged so as to keep a narrower gap than the film thickness in order to press the film against a stationary guide surface 12d of the heating guide 12b.

The temperature retaining section 13 includes a fixed flat heating guide 13b made of a metallic material such as aluminum, a flat heater 13c composed of a silicon rubber heater or the like adhered to the rear of the heating guide 13b, and a guide section 13a composed of a heat insulator arranged opposite to a stationary guide surface 13d formed on the surface of the heating guide 13b so as to have a predetermined gap (slit) d.

In the first heating zone 11 of the temperature raising section 10, the film F conveyed by a pair of conveying rollers 16 from the upstream side of the temperature raising section 10 is pressed against the stationary guide face 11d by the respective opposing rollers 11a driven to rotate, thus the BC surface makes close contact with the stationary guide face 11d and is conveyed in the direction H while being heated.

Similarly in the second heating zone 12, the film F conveyed from the first heating zone 11 is pressed against the stationary guide face 12d by the respective opposing rollers 12a driven to rotate, thus the BC surface makes close contact with the stationary guide face 11d and is conveyed in the direction H while being heated.

Between the second heating zone 12 of the temperature raising section 10 and the temperature retaining section 13, a concavity 17 opened upward in a V shape is installed and is structured so that foreign substances from the temperature raising section 10 fall into the concavity 17. By means of this, foreign substances from the temperature raising section 10 are prevented from being carried in the temperature retaining section 13 and the film F can be prevented from an occurrence of jamming, scratching, and uneven density.

In the temperature retaining section 13, the film F conveyed from the second heating zone 12, while being heated (heat retained) by the heat from the heating guide 13b in the gap “d” between the stationary guide face 13d of the heating guide 13b and the guide section 13a, passes through the gap “d” by the conveying force of the opposing rollers 12a on the side of the second heating zone 12.

As is shown in FIG. 1, the configuration is such that the distance “m” from the exposure position 15b of the film F in the light scanning exposure section 15 up to the opposing roller 11a in the most upstream position of the first heating zone 11 of the temperature raising section 10 is shorter than the length of the film F in the conveying direction H. Therefore while carrying out exposure of the film F by the light scanning exposure section 15, heating of heat development is done at the front edge of the film F in the temperature raising section 10 and the temperature retaining section 13. Further, since the overall length of the film conveying path can be shortened, this contributes to reducing the size of the apparatus.

The density correction section (slow cooling section) 18 is constructed of a cooling plate 18a that comes into contact with the back surface (surface BC) of the heated film, and a flat heater 18b, made of a silicon rubber heater or the like, placed so as to directly heat the cooling plate 18a. The temperature sensor 19 is placed near the surface of the cooling plate 18a. The film F is conveyed while being in contact with the guide surface 18c of the cooling plate 18a by a plurality of opposing rollers 18d placed above the cooling plate 18a. Further, the cooling effect can be increased by allowing the cooling plate 18a to have a heat sink structure with cooling fins.

In the rapid cooling section 14, the film F is conveyed further in the conveying direction H by the opposing rollers 14a while cooling it by allowing it to be in contact with the cooling guide surface 14c of the cooling plate 14b made of a metallic material or the like. Cooling ratio with respect to transport speed in the rapid cooling section 14 is greater than that in the density correction section (slow cooling section) 18. In addition, the temperature sensor 19d is placed near the surface of the cooling guide surface 14c of the cooling plate 14b.

Further, when the cooling plate 14b is formed as a finned heat sink structure, the cooling effect (cooling ratio) can be increased. A cooling plate of a finned heat sink structure may be arranged additionally on the downstream side of the cooling plate 14b.

Using FIG. 2, the temperature control of the various heaters 11c, 12c, and 13c of the temperature raising section 10 and the temperature retaining section 13, and the heater 18b of the density correction section (slow cooling section) 18 is explained hereunder. FIG. 2 is a block diagram showing the major parts of the control system of the heat-development recording apparatus 1 of FIG. 1.

As is shown in FIG. 2, the temperature control system of the heat-development recording apparatus 1 is provided with a control section 20 configured using a central processing unit (CPU). The control section 20 is inputted with signals from the temperature sensors 19a, 19b, and 19c placed at the different heating guides 11b, 12b, and 13b of the temperature raising section 10 and the temperature retaining section 13 of FIG. 1, from the temperature sensor 19 placed in the cooling plate 18a, from the temperature sensor 19d placed in the rapid cooling section 14, and from the temperature sensor 15a of the laser diode (LD) placed in the light scanning exposure section 15. The control section 20 controls the respective heaters 11c, 12c, 13c, and 18b based on the measurement results of the different temperature sensors 19a, 19b, 19c, 19, and 15a.

As mentioned above, in the heat-development recording apparatus 1 shown in FIG. 1, the film F is conveyed while the BC surface is directed toward the stationary guide surfaces 11d, 12d, and 13d in the heated state in the temperature raising section 10 and the temperature retaining section 13 and the EC surface where the heat-development photosensitive material is coated is opened to air.

Further, in the density correction section (slow cooling section) 18, the film F heated in the temperature raising section 10 and the temperature retaining section 13 comes into contact with the guide surface 18c of the cooling plate 18a, and is transported while being cooled with an appropriate temperature difference. At this time, the temperature of the density correction section (slow cooling section) 18 is controlled so as to keep the final density of the film F to be constant by controlling the heater 18b based on the result of measurement by the temperature sensor 19 of the cooling plate 18a.

In addition, in the rapid cooling section 14, the surface BC of the film F indicated by a dot and dash line is cooled faster than in the density correction section (slow cooling section) 18 by being in contact with the cooling guide surface 14c, and the film F is conveyed in the state in which its surface EC that has been coated with heat-development material is exposed freely to ambient atmosphere.

Further, the film F is conveyed by the opposing rollers 11a and 12a so that the passing time through the temperature raising section 10 and the temperature retaining section 13 becomes 10 seconds or less. Therefore, the heating time for temperature raising and temperature retaining is set to 10 seconds or less and quick processing of heat development becomes possible.

Further, the film F is conveyed so that it is ejected to the outside of the apparatus within 25 seconds after the development in the temperature raising section 10 and the temperature retaining section 13. In addition, when carrying out heat development successively of plural sheets of film, the interval between the sheets can be set 12 seconds or less.

As mentioned above, according to the heat-development recording apparatus 1 shown in FIG. 1, in the temperature raising section 10 requiring uniform heat transfer, the film F is adhered to the stationary guide surfaces 11d and 12d by the heating guides 11b and 12b and the plurality of opposing rollers 11a and 12a for pressing the film F against the heating guides 11b and 12b, thus the film F is conveyed while ensuring close contact for heat transfer. Therefore, overall the film is heated uniformly and is uniformly raised in temperature, thus the final film forms a high-quality image with an occurrence of uneven density suppressed.

Further, after temperature rise to the heat developing temperature, even if in the temperature retaining section 13 the film is conveyed into the gap “d” between the stationary guide surface 13d of the heating guide 13b and the guide section 13a, and the temperature retaining section 13 heats it (the film directly makes contact with the stationary guide surface 13d and is heated by heat transfer and/or heat transfer by contact with surrounding high-temperature air) in the gap “d” without particularly being adhered to the stationary guide surface 13d, the film temperature is controlled within a predetermined range (for example, 0.5° C.) of the development temperature (for example, 123° C.). As mentioned above, even if the film is conveyed in the gap “d” along the wall face of the heating guide 13b or the wall face of the guide 13a, a difference in the film temperature is less than 0.5° C. and a uniform temperature retaining state can be kept, so that there is little possibility of an occurrence of uneven density in the finished film. Therefore, there is no need to install drive parts such as rollers in the temperature retaining section 13, thus the number of parts can be reduced.

Further, the development of the film F progresses even after it is ejected from the temperature retaining section 13 because it will still be at a relatively high temperature. The quantity of heat absorbed (quantity of heat transferred) from the film F can be controlled by controlling the temperature of the guide surface 18c of the cooling plate 18a in the density correction section (slow cooling section) 18 based on the result of measurement by the temperature sensor 19 while slowly cooling in the density correction section (slow cooling section) 18. Density correction can be carried out as described above while controlling the density by adjusting the temperature at the time of the slow cooling. In this manner, an optimum and also new density correction system can be realized when heat development is carried out simultaneously with exposure and the final density of the film F can be stabilized.

In a small sized quick processing apparatus as in the present preferred embodiment, curling or wrinkles can be generated easily if the heated film is cooled quickly in such a cooling section that has a curved transport path. Also the temperature of the cooling section itself rises because of absorbed heat during continuous operation and the capacity (heat absorption capacity or cooling capacity) easily changes thereby causing the changes in the density. Even if an attempt is made to control this under the capacity of the cooling section, the response to very small temperature changes corresponding to very small density differences is poor because the cooling section is originally a part that controls large quantities of heat variations (heat transfer) and cannot respond to small temperature changes. However, according to the heat-development recording apparatus 1 of the present preferred embodiment, which is different from the conventional method of activating a fan or a heat pipe according to the temperature of the cooling environment, even when continuous operation with an interval of 12 seconds or less is made, by providing a heater 18b in the density correction section (slow cooling section) 18 (corresponds to the conventional heat insulating felt guide) and carrying out temperature control during the slow cooling, it is possible not only to prevent the generation of curling or wrinkles in the film but also to control the density with very small amount of changes.

Further, in the density correction section (slow cooling section) 18, as in conventional methods, the ambient temperature rises due to heat of the film generated during continuous operation, and even the temperature of the cooling plate 18a is affected. Although there is a trend of gradual decrease in the quantity of heat taken away from the film (trend of increasing density), by controlling the temperature of the heater 18b using the temperature sensor 19 of the cooling plate 18a, the quantity of heat taken away from the film can be controlled in real time when the film is passing over the cooling plate 18a and hence the ultimate final density of the film can be controlled.

Further, even when the wavelength of oscillation of the LD (laser diode) included in the light scanning exposure section 15 changes due to temperature rise and thus the amount of light in the photosensitive wavelength range of the film F becomes decreased, the temperature of the LD is measured by the temperature sensor 15a shown in FIG. 2 and the surface temperature of the guide surface 18c is controlled by controlling the heater 18b based on the result of that measurement. Thereby, reductions in the density can be prevented.

Furthermore, the heating time for the film F is sufficiently 10 seconds or less, so that a rapid heat developing process can be realized, and the film conveyance path linearly extended from the temperature raising section 10 to the rapid cooling section 14 can be changed into a curved path according to the apparatus layout, especially a linear temperature raising section and linear slow and rapid cooling sections can be connected by a temperature retaining section forming a curved path and miniaturization of the foot print and miniaturization of the overall apparatus volume can be realized.

In a conventional large-sized apparatus, for the part which can be operated sufficiently by only the temperature retaining function after the film temperature was raised to the development temperature, the same heating conveyance constitution as that of the temperature rising section was adopted, so that unnecessary members were used after all, and increasing in the number of parts and increasing in cost were caused. In a conventional small-sized apparatus, a problem arose that heat transfer at time of temperature rise could be hardly guaranteed, so that uneven density was generated, and high image quality could be hardly guaranteed. On the other hand, according to the embodiment, the heat developing process is executed separately in the temperature raising section 10 and the temperature retaining section 13, thus the problems aforementioned can be solved.

Further, the film F is heated from the BC surface side by the temperature raising section 10 and the temperature retaining section 13 while the EC surface with the heat-development photosensitive material coated is opened to air, thus when executing the heat developing process by the rapid process of 10 seconds or less, by opening the EC surface side, the solvents (moisture, organic solvent, etc.) contained in the film F which are heated and intended to volatilize (evaporate) are scattered at the shortest distance, so that even if the heating time (volatilization time) is shortened, the sheet film is hardly affected by the shortened time, and even if there is a part where the contact between the film F and the stationary guide surfaces 11d and 12d is not enough, by the heat diffusion effect by the PET base of the BC surface, a temperature difference from the part where the contact is satisfactory is relaxed, and as a result, a density difference hardly appears, so that the density can be stabilized, and the image quality becomes stable. Further, generally, in consideration of the heating efficiency, heating of the EC surface side is considered to be better. However, in consideration of that the thermal conductivity of the PET of the supporting substrate of the film F is 17 W/m ° C. and the thickness of the PET base is about 170 μm, the time delay is little, and it can be offset easily by increasing the heater capacity, and therefore the aforementioned effect of relaxing uneven contact is more expected preferably.

Furthermore, between the temperature retaining section 13 and the rapid cooling section 14, the solvents (moisture, organic solvent, etc.) contained in the film F are intended to volatilize (evaporate) because they are at a high temperature. The EC surface of the film F is opened in the rapid cooling section 14, so that the solvents (moisture, organic solvent, etc.) are not trapped and are volatilized for a longer period of time, thus the image quality (density) is stabilized more. As mentioned above, in the rapid process, the cooling time cannot be ignored and it is particularly effective in the rapid process of a heating time of 10 seconds or less.

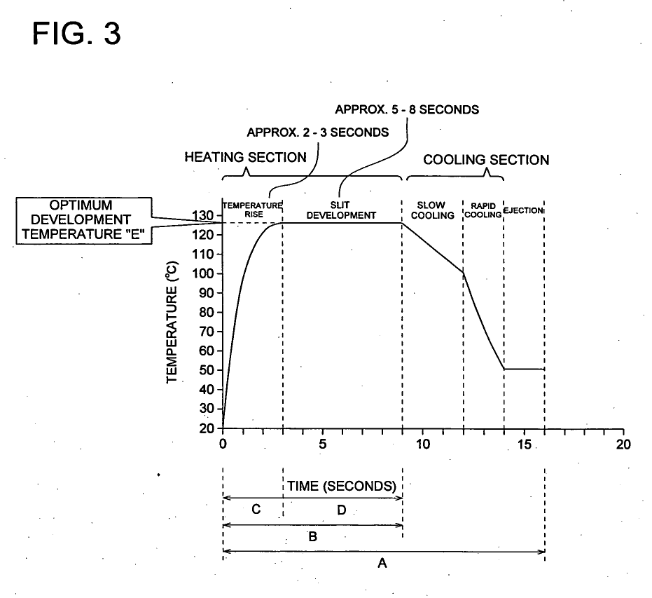

Next, the rapid process of the heat developing process in the embodiment will be explained by referring to FIG. 3. FIG. 3 is a graph showing the temperature profile by the rapid processing method of the heat developing process of the heat-development recording apparatuses 1 shown in FIG. 1.

The rapid processing method shortens more the heating time B, as shown in FIG. 3, to shorten the total processing time A of a film in the heat-development recording apparatuses 1 shown in FIG. 1. Therefore, to shorten more the temperature raising time “C” up to the optimum development temperature “E” (123° C. for example), in the temperature raising sections 10, the film F is pressed by the opposing rollers 11a and 12a, and makes close contact with the stationary guide surfaces 11d and 12d for rapid heat transfer from guide facing to the film.

And, after the temperature of film F reaches the optimum development temperature. “E”, in the temperature retaining sections 13, the film F is retained at the heat-developing temperature for the temperature retaining time D. The temperature retaining sections 13, as described above, convey the film F in the gap (slit) “d” free of pressing by the opposing rollers and without close contact with the stationary guide surfaces 13d.

Next, the film coming out of the temperature retaining section 13 is cooled slowly in the density correction section (slow cooling section) 18, and thereafter it is cooled quickly in the rapid cooling section 14. Further, the slow cooling in the density correction section (slow cooling section) 18 is the cooling in the range from the development temperature of 123° C. to the development stopping temperature of 100° C. Further, the quick cooling in the rapid cooling section 14 can be realized by placing a heat sink or a cooling fan etc.

As described above, in the state that the image quality is maintained, the heating time B (temperature rising time C+temperature retaining time D) can be shortened from conventional 14 seconds or so to 10 seconds or less, and the total processing time A can be shortened.

### EXAMPLE

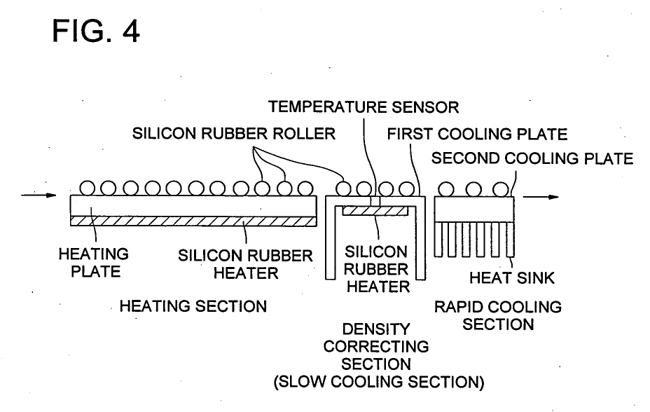

Next, the effect of the slow cooling section in the quick heating processing is explained by means of examples below. The heat-development recording apparatus shown in FIG. 4 was used for the experiments and was configured as follows.

As a heating system, a heating plate composed of an aluminum plate with a thickness of 10 mm having a silicon rubber heater attached on the rear thereof was used. On each guide surface of the heating plates, a silicon rubber roller with a diameter of 12 mm and an effective conveyance width of 380 mm having a silicon rubber layer with a thickness of 1 mm as a surface layer was arranged at a nip pressure of about 8 gf/cm over the width, and a film with a heat-development photosensitive material coated was pressed by the silicon rubber rollers and was conveyed in the state that the BC surface was in contact with the heating plates. The conveyance lengths of the heating plate was 210 mm.

An aluminum plates with thicknesses of 2 mm and 10 mm were used as the first and the second cooling plates of the cooling section, a heater was provided on the surface opposite to the film conveying surface of the first cooling plate, thereby making it possible to carry out temperature control. Also, the edge parts of these cooling plates are extended to increase their area thus increasing their (cooling) heat transfer efficiency.

To the rear of the aluminum plate of the second cooling plate, a heat sink with a thickness of 0.7 mm, a height of 35 mm, and a depth (width) of 390 mm having 21 fins arranged at a pitch of 4 mm was joined. On the first and second cooling plates, a silicon rubber roller with a diameter of 12 mm and an effective conveyance width of 380 mm having a silicon rubber layer with a thickness of 1 mm as a surface layer was arranged at a linear pressure of about 8 gf/cm and a film was conveyed while being pressed. The conveyance lengths of the first and second cooling plates were respectively 60 mm and 105 mm.

Quick processing was done with a conveying speed of 21.2 mm/s. The temperature of the heating plate was set as 123° C., and control was carried out by providing a heater on the first cooling plate with which temperature adjustment can be carried out in the range of ±5° C. with respect to a standard value of 100° C. of the plate surface temperature. A spacing of 2 mm was provided between the plates so as to suppress the quantity of heat transferred between the plates.

The heat developing film was SD-P manufactured by Konica Minolta Co., Ltd., which was a heat developing film of the organic solvent system as disclosed in Japanese Patent Application Tokkai No. 2004-102263.

Using above films, the heat developing process was executed in the heat-development recording apparatus shown in FIG. 4. The films were conveyed by opening the EC layer surface (EC surface) side, pressing by the silicon rubber rollers, and making the BC surface contact with the heating plate, and the heating time B shown in FIG. 3 was set to 10 seconds, and the heat development was executed.

At the time of heat development processing of 40 sheets of films exposed so as to get a target density of 1.5, the plate surface temperature was gradually lowered as the number of sheets processed increased, and during conveying the film close to the 40th sheet, the heater was controlled so that the plate surface temperature was −3° C. with respect to a standard value of 100° C., as a result of which the fluctuation in the final density among the 40 sheets of film could be suppressed to D=0.05 or less.

On the other hand, as a result of carrying out continuous operation under the same conditions as the example excepting that the temperature control of the first cooling plate was not done, the ambient temperature near the slow cooling section and the temperature of the first cooling plate rose due to continuous processing, the quantity of heat absorption from the heated film gradually decreased, and the density tended to increase, and then the difference in the densities of the first and the 40th sheets was D=0.2 or more, thereby confirming the effect of the present invention.

The preferred embodiments of the present invention are explained above. However, the present invention is not limited to these embodiments and can be modified variously within the scope of technical thought. For example, in the embodiments, when producing films, a solvent of organic solvent type is used, though an aqueous solvent can be used. Heat developing films using an aqueous solvent are produced as indicated below.

Namely, a PET film is coated with an organic silver salt containing layer using a coating solution containing water of 30 wt % or more of the solvent, is dried, and formed, and a heat-development photosensitive film with a thickness of 200 μm is produced. The binder of the organic silver salt containing layer can be dissolved or dispersed in a aqueous solvent (water solvent) and is composed of latex of a polymer having an equilibrium moisture content of 2 wt % or less at 25° C. and 60% RH. The aqueous solvent composed of the polymer which can be dissolved or scattered is water or water mixed with a water-miscible organic solvent of 70 wt % or less. As a water-miscible organic solvent, for example, alcohols such as methyl alcohol, ethyl alcohol, and propyl alcohol, the Cellosolves such as methyl Cellosolve, ethyl Cellosolve, and butyl Cellosolve, and ethyl acetate and dimethylformamide may be cited.

Specifically, the emulsion layer (photosensitive layer) coating solution is prepared as indicated below. To a fatty acid silver dispersion of 1000 g and water of 276 ml, a pigment-1 dispersion, an organic polyhalogen compound-1 dispersion, an organic polyhalogen compound-2 dispersion, a phthalazine compound-1 solvent, an SBR latex (Tg, 17° C.) liquid, a reducing agent-1 dispersion, a reducing agent-2 dispersion, a hydrogen bonding compound-1 dispersion, a development promoter-1 dispersion, a development promoter-2 dispersion, a color adjusting agent-1 dispersion, a mercapto-compound-1 water solution, and a mercapto-compound-2 water solution are added sequentially, and a silver halide mixed emulsion is added immediately before coating, and the emulsion layer coating solution obtained by sufficiently mixing them is sent straight to the coating die and is coated.

According to the heat-development recording apparatus and heat-development recording method of the present invention, an optimum and new density correction system and method can be realized that can stabilize the final density when carrying out heat development while carrying out exposure.

What is claimed is:

1. A heat-development recording apparatus comprising:
an exposure device for exposing a sheet-shaped heat-development photosensitive material and forming a latent image on the photosensitive material;
a heater for heating and developing the photosensitive material;
a cooling device for cooling the heated photosensitive material;
a density correction device for controlling a density of the photosensitive material by varying quantity of absorbed heat from the photosensitive material while engaging the heated photosensitive material conveyed to the cooling device; and
a controller for controlling the density correction device.

2. The apparatus of claim 1,
wherein the exposure device and the heater operate on the photosensitive material simultaneously.

3. The apparatus of claim 1,
wherein the density correction device comprises:
a guide coming in contact with the heated photosensitive material;
a heating section provided on an opposite side of a contacting surface between the guide and the photosensitive material.

4. The apparatus of claim 1,
wherein the cooling device comprises:
a slow cooling section for cooling the heated photosensitive material down to a development stopping temperature; and
a rapid cooling section for cooling the photosensitive material down to a temperature at which the photosensitive material is touchable,
wherein the slow cooling section is positioned on an upstream side of the rapid cooling section.

5. The apparatus of claim 3,
wherein the cooling device comprises a slow cooling section for cooling the heated photosensitive material down to a development stopping temperature and the heating section is provided on an entrance side of the slow cooling section where the photosensitive material enters the slow cooling section and the slow cooling section operates as the density correction device.

6. The apparatus of claim 4, further comprising,
a temperature detecting section for detecting temperature in a vicinity of at least one of the slow cooling section and the exposure device,
wherein the controller controls the heating section of the density correction device based on a detecting result of the temperature detecting section.

7. The apparatus of claim 1,
wherein a heating time of the photosensitive material by the heater is less than 10 seconds.

8. A heat-development recording method, comprising steps of:
exposing a sheet-shaped heat-development photosensitive material to form a latent image on the photosensitive material;
heating to develop the photosensitive material;
cooling the heated photosensitive material; and
correcting a density by controlling a density of the photosensitive material while varying a quantity of absorbed heat from the photosensitive material conveyed for the cooling step.

9. The method of claim 8,
wherein the exposing step and the heating step are carried out on the photosensitive material simultaneously.

10. The method of claim 8,
wherein the cooling step comprises a slow cooling step in which the heated photosensitive material is cooled down slowly to a development stopping temperature, and after the slow cooling step, the photosensitive material is cooled down to a temperature at which the photosensitive material is touchable.

11. The method of claim 10,
wherein the density correcting step of the photosensitive material is carried out during the slow cooling step.

12. The method of claim 8,
wherein during the density correcting step, the heated photosensitive material comes in contact with a guide and a surface of the guide opposite to a contacting surface coming in contact with the photosensitive material is heated.

13. The method of claim 10,
wherein a temperature in a position relating to at least one of the slow cooling step and the exposing step is detected and heating of the guide is controlled based on a detection result of the temperature.

14. The method of claim 8,
wherein a heating time of the photosensitive material after formation of the latent image is less than 10 seconds.
